(19) United States
(12) Patent Application Publication
(10) Pub. No.: US 2012/0067830 A1
(43) Pub. Date: Mar. 22, 2012

(54) Removing Organic Impurities from Bayer Process Liquors

(75) Inventors: Jose Antonio Alarco, Queensland (AU); Peter Cade Talbot, Queensland (AU)

(73) Assignee: Very Small Particle Company Pty Ltd, Queensland (AU)

(21) Appl. No.: 13/257,629

(22) PCT Filed: Mar. 19, 2010
(86) PCT No.: PCT/AU2010/000319

§ 371 Date: Dec. 5, 2011

(30) Foreign Application Priority Data
Mar. 20, 2009 (AU) 2009901212

(51) Int. Cl. B01D 17/00

(52) U.S. Cl. 210/758

(57) ABSTRACT

A process for treating a Bayer liquor by wet oxidation to oxidise organic contaminants in the Bayer liquor in which the wet oxidation process is conducted in the presence of a mixed Ce/Mn oxide. The catalyst may have nano-sized grains, and be supported on a mesoporous oxide support. The catalyst may also contain a platinum group metal.

### FIELD OF THE INVENTION

The present invention relates to a method for treating a liquor or a solution. More particularly, the present invention relates to a method for treating a liquor or solution used in the Bayer process. In another aspect, the present invention also relates to a wet oxidation catalyst used in treating a Bayer process liquor or solution.

### BACKGROUND TO THE INVENTION

The Bayer process is a well-known process used for extracting alumina from bauxite ores. In the Bayer process, bauxite ore is mixed with a strong caustic liquor under elevated temperatures and pressures. This causes the alumina present in the bauxite to be dissolved and go into solution. This process is referred to as digestion or extraction.

The insoluble residues in the bauxite are subsequently separated from the loaded liquor (which is normally referred to as a “pregnant liquor”). The insoluble residues, which are called “red mud” and then disposed of, typically by placement in a red mud pond or a landfill.

The pregnant liquor is then sent to the precipitation or decomposition stage. In this stage, the pregnant liquor is seeded with seed crystals of alumina trihydrate and the pregnant liquor and seed crystals are subsequently cooled as a pass through a number of precipitation vessels. Cooling of the liquor causes precipitation and growth of alumina trihydrate, which is subsequently recovered from the liquor at the end of the precipitation stage. The caustic liquor recovered from the precipitation stage (which is referred to as spent liquor) is recycled to the digestion stage. The alumina trihydrate particles are sent to a calcination stage, where they are calcined to form alumina.

The Bayer process has been practised industrially since the late 1800s and today is used in the production of many millions of tonnes of alumina each year.

Bauxite ores that are used as the feed material to the Bayer process often contain organic material, such as in the form of leaves, twigs and humus. These organic materials tend to go into solution in the digestion stage of the Bayer process, thereby resulting in the Bayer process liquor having a content of dissolved organic material. If this dissolved organic material is not treated, it collects in the Bayer process liquor and the concentration of dissolved material will increase with time. The presence of dissolved organic material in the process liquor causes difficulties in the precipitation stage of the Bayer process. Therefore, it is desirable to remove these components from Bayer process liquors.

A number of attempts have previously been made to try to remove organic components from Bayer process liquors. One process involves liquor burning, in which a side stream of liquor is treated at high temperatures to degrade the organic components. Due to the high construction costs and operating costs associated with liquor burning, its use thus far has been limited to side streams of the Bayer process liquor.

Several efforts have also been made to try to treat the Bayer process liquors using wet oxidation. Wet oxidation involves treating the liquor at elevated temperatures and pressures, such as from 180 to 315° C. at pressures of from 1 to 10 Mpa, in the presence of air or oxygen to cause oxidation of the organic components. In order to improve the rate of wet oxidation, it is common to use a wet oxidation catalyst.

U.S. Pat. No. 4,215,094, assigned to Sumitomo Aluminium Smelting Company, Limited, describes a wet oxidation process for treating Bayer process liquors in which the wet oxidation process takes place in the presence of copper ions as a catalyst. In this process, the copper ions that act as a catalyst are present in the form of dissolved ions. Following the wet oxidation step, a precipitating agent, such as sodium sulphide, that precipitates the copper ions is added to the liquor to precipitate copper therefrom. This increases the capital costs and operating costs of the process. It is also believed that the precipitated copper sulphide is difficult to separate by filtration.

U.S. Pat. No. 4,668,486, assigned to Vereinigte Aluminium-Werke AG, describes a wet oxidation process for treating Bayer liquors. In the wet oxidation process, copper ions are used as a catalyst. The copper ions are precipitated jointly with boehmite (a form of alumina) and the precipitated copper/boehmite is separated from the Bayer liquor. This precipitated material is subsequently recycled to the wet oxidation process, in which the precipitate again dissolves to liberate catalytic copper ions.

Australian patent application No. 200017606 in the name of Alcoa of Australia Ltd describes a catalyst for use in the wet oxidation of the Bayer liquors. The catalyst comprises a mixed copper-manganese oxide the catalyst may be supported on an aluminium oxide substrate. Testwork conducted by the present inventors has suggested that this catalyst loses its active metal species by leaching of those species into the Bayer liquors.

Accordingly, there remains a requirement to provide a process for treating Bayer liquors to reduce the organic components contained therein whilst avoiding the disadvantages associated with the prior discussed above.

Throughout the specification, the term “comprising” and its grammatical equivalents shall be taken to have an inclusive meaning unless the context of use indicates otherwise.

The applicant does not concede that the prior art discussed in the specification forms part of the common general knowledge in Australia or elsewhere.

### BRIEF DESCRIPTION OF THE INVENTION

In a first aspect, the present invention provides a process for treating a Bayer liquor by wet oxidation to oxidise organic components in the Bayer liquor, characterised in that the wet oxidation process is conducted in the presence of a catalyst comprising a mixed Ce/Mn oxide.

Preferably, the catalyst has Ce atoms and Mn atoms homogenously dispersed.

The catalyst may have a molar ratio of Mn:Ce ranging from 1:99 to 99:1, more preferably from 10:1 to 1:10, even more preferably from 3:1 to 1:3. It is believed that especially suitable catalysts are likely to have a ratio of Mn:Ce of from 0.5:0.5 to 0.8:0.2, more suitably 0.6:0.4 to 0.75:0.25.

In some embodiments, the catalyst may include one or more platinum group metals. These metals may be selected from platinum, palladium, ruthenium, and rhodium. When a platinum group metal is included in the catalyst, it may be present in an amount of up to 10% by weight of the Ce/Mn oxide.

In some embodiments, the catalyst may have nano sized grains. For example, the catalyst may have an average grain size of up to 100 nm, or even an average grain size of up to 50 nm, or even an average grain size of up to 20 nm, or even an average grain size of from 1 to 10 nm, or even an average grain size of from 2 to 5 nm.

The catalyst may be provided in the form of particles of the Ce/Mn oxide. In other embodiments, the catalyst may be supported on an inert support. If an inert support is used, it is desirable that the inert support is not soluble in Bayer process liquors. Such a support oxide could be, but not limited to, oxides of Ti, Fe and Ce.

In one embodiment, the catalyst may be made using a process as described in our U.S. Pat. No. 6,752,979, the entire contents of which are incorporated herein by cross-reference. In the process according to our U.S. Pat. No. 6,752,979, a solution containing cerium ions and manganese ions in the desired ratio is formed and a surfactant added thereto to form a micellar liquid. The micellar liquid is then heated to form the Ce/Mn oxide having nano sized grains.

In other embodiments, the catalyst may be made using a process for the production of metal oxide powders, wherein metal oxide precipitates or metal oxide gels are formed by mixing surfactant with aqueous solutions containing metal salts. The surfactant and salt types are chosen so that a precipitate or gel of the metal oxide forms on mixing. The metal oxide precipitates or metal oxide gels are separated from the rest of the mixture and then further heat treated to obtain metal oxide powders. Such a process is described in U.S. Pat. No. 6,139,816 (Liu et al), the entire contents of which are herein incorporated by cross reference.

In another embodiment, the catalyst may be produced by mixing a solution containing metal cations with hydrophilic polymers to form a hydrophilic polymer gel. The hydrophilic polymer gel is then heated to drive off water and organics, leaving a nanometre-sized metal oxide powder. Such a process is described in U.S. Pat. No. 5,698,483 (Ong et al), the entire contents of which are herein incorporated by cross reference.

In yet another embodiment, the catalyst may be produced by a process for producing fine particles of metal oxide having diameters of about 20 nm or smaller by hydrolyzing metal halides in the presence of an organic solvent, such as described in U.S. Pat. No. 6,328,947 (Monden et al), the entire contents of which are herein incorporated by cross reference. In Monden et al, metal oxides are formed by hydrolysis of metal halides in organic solution. The metal oxide precipitates are then separated from the mother solution (for example, by filtration, centrifugation and so forth), washed and then dried.

In a further embodiment, the catalyst may be produced by a process as described in U.S. Pat. No. 5,879,715 (Higgins et al) and U.S. Pat. No. 5,770,172 (Linehan et al), the entire contents of which are herein incorporated by cross reference. These United States patent described describe processes for production of nano-particles by using microemulsion methods. In these processes, a microemulsion is formed and metal oxides are precipitated within the microemulsion micelles, thereby limiting the size of the metal oxide particles to approximately the size of the droplets. In Higgins et al, two water-in-oil emulsions are prepared, one with dissolved metal salt in the water droplets and the other with a reactant in the water droplets. The microemulsions are mixed and when the reactant-containing droplets contact the metal solution-containing droplets, precipitation of metal oxide occurs. In Linehan et al, a water-in-oil microemulsion is formed with dissolved metal salt in the water droplets. A reactant is then added to the system, for example, by bubbling a gaseous reactant therethrough, to precipitate metal oxide in the water droplets.

In a further still embodiment, the catalyst may be produced by a process as described in U.S. Pat. No. 5,788,950 (Imamura et al), the entire contents of which are herein incorporated by cross reference. This United States patent describes describes a process to synthesise complex metal oxide powders using liquid absorbent resin gels. In Imamura et al, a solution containing at least two dissolved metals is contacted with a liquid absorbent resin such that at least two metals are present in the liquid absorbent resin after combining with the solution. The liquid absorbent resin is allowed to swell and gel. The swollen gel is treated by changing at least one of the pH or temperature of the swollen gel to form a precursor material. The precursor material is pyrolyzed and calcined to form the mixed metal oxide powder.

In a further still embodiment, the catalyst may be produced by a method as described in German patent document number DE 19852547, the entire contents of which are herein incorporated by cross reference. This patent describes a process for producing metal oxide powders by treating aqueous solutions of metal salts with an aqueous base to produce a precipitate (condensate) in the presence of a water soluble stabiliser.

In yet another embodiment, the catalyst may be produced by a process as described in U.S. patent application No. 2005/0008777 (McCleskey et al), the entire contents of which are herein incorporated by cross reference. This United States patent application describes a process for forming metal oxide films. The process involves preparing solutions of one or more metal precursors and soluble polymers having binding properties for the one or more metal precursors. After a coating operation, the resultant coating is heated at high temperatures to yield metal oxide films.

In some embodiments, the catalyst may have pores size in the range of from 5 to 250 nm. These pores may be formed, for example, by adding a pore forming agent to the mixture is used to benefit the catalyst and subsequently removing the pore forming agent from the catalyst. The pore forming agent may be burned out from the catalyst during the heating step. Alternatively, the pore forming agent may be removed by washing or dissolving the pore forming agent from the catalyst.

The wet oxidation treatment step may take place at any stage in the Bayer process. However, it is desirable that the wet oxidation step be used to treat the spent liquor from the sedimentation step, as this will minimise the amount of liquor to be treated. It will also be appreciated that a side stream of liquor may be removed from the Bayer process and subject to a wet oxidation treatment in accordance with the present invention, with the thus-treated liquor being returned to the Bayer process.

The wet oxidation treatment step may be conducted under any conditions known to the person skilled in the art to be suitable for the wet oxidation of Bayer process liquors. For an example, the wet oxidation process may be conducted at a temperature of from 200 to 315° C. and at a pressure of from 1 to 10 Mpa. However, it will be appreciated that the wet oxidation treatment step need not be restricted to these particular treatment parameters.

In the second aspect, the present invention provides a wet oxidation catalyst used in a wet oxidation treatment of Bayer process liquors, the wet oxidation catalyst comprising a mixed Ce/Mn oxide material.

### EXAMPLES

### Example 1

A complex metal oxide of the nominal formula Mn_{0.62}Ce_{0.38} was produced as follows.

A solution containing all the required elements was made by mixing 60 mls of water, 153.10 g of manganese nitrate solution (15.38 w % Mn) and 115.80 g of cerium nitrate hexahydrate.

The solution was then added to 16 g of carbon black and mixed with a high-speed stirrer. The resulting mixture was added to 70 g of anionic surfactant and again mixed with a high-speed stirrer.

The final mixture was heat treated slowly to 650° C. in air and held at this temperature for 0.5 hr.

### Example 2

A complex metal oxide of the nominal formula Mn_{0.62}Ce_{0.38} was produced as follows.

A solution containing all the required elements was made by mixing 60 mls of water, 153.10 g of manganese nitrate solution (15.38 w % Mn) and 115.80 g of cerium nitrate hexahydrate. 40 g of ruthenium solution (1.5 w % Ru) was then added to give approximately 0.72 w % of ruthenium metal in the final compound.

The solution was then added to 16 g of carbon black and mixed with a high-speed stirrer. The resulting mixture was added to 70 g of anionic surfactant and again mixed with a high-speed stirrer.

The final mixture was heat treated slowly to 650° C. in air and held at this temperature for 0.5 hr.

### Example 3

A complex metal oxide of the nominal formula Mn_{0.62}Ce_{0.38} was produced as follows.

A solution containing all the required elements was made by mixing 60 mls of water, 153.10 g of manganese nitrate solution (15.38 w % Mn) and 115.80 g of cerium nitrate hexahydrate. A second solution was made consisting of 15 g sodium carbonate in 50 g of water and 30 g of nitric acid. Both solutions were mixed and the resulting mixture was added to 70 g of anionic surfactant and mixed with a high-speed stirrer.

The final mixture was heat treated slowly to 650° C. in air and held at this temperature for 0.5 hr.

### Example 4

A complex metal oxide of the nominal formula Mn_{0.79}Ce_{0.21} was produced as follows.

A solution containing all the required elements was made by mixing 60 mls of water, 107.17 g of manganese nitrate solution (15.38 w % Mn), and 34.74 g of cerium nitrate hexahydrate.

The solution was then added to 16 g of carbon black and mixed with a high-speed stirrer. The resulting mixture was added to 70 g of anionic surfactant and again mixed with a high-speed stirrer.

The final mixture was heat treated slowly to 500° C. in air and held at this temperature for 0.5 hr.

### Example 5

A complex metal oxide of the nominal formula Mn_{0.7}Ce_{0.3} was produced as follows.

A solution containing all the required elements was made by mixing 60 mls of water, 66.81 g of manganese nitrate solution (15.38 w % Mn) and 34.74 g of cerium nitrate hexahydrate. 40 g of ruthenium solution (1.5 w % Ru) was then added to give approximately 1.96 w % of ruthenium metal in the final compound.

The solution was then added to 16 g of carbon black and mixed with a high-speed stirrer. The resulting mixture was added to 70 g of anionic surfactant and again mixed with a high-speed stirrer.

The final mixture was heat treated slowly to 500° C. in air and held at this temperature for 0.5 hr.

### Example 6

A complex metal oxide of the nominal formula Mn_{0.7}Ce_{0.3} was produced as follows.

A solution containing all the required elements was made by mixing 60 mls of water, 66.81 g of manganese nitrate solution (15.38 w % Mn), and 34.74 g of cerium nitrate hexahydrate.

The solution was then added to 16 g of carbon black and mixed with a high-speed stirrer. The resulting mixture was added to 70 g of anionic surfactant and again mixed with a high-speed stirrer.

The final mixture was heat treated slowly to 500° C. in air and held at this temperature for 0.5 hr.

The above catalysts all showed satisfactory activity as wet oxidation catalysts for Bayer liquors.

Those skilled in the art will appreciate that the present invention may be susceptible to variations and modifications other than those specifically described. It will be understood that the present invention encompasses all such variations and modifications that fall within its spirit and scope.

1. A process for treating a Bayer liquor by wet oxidation to oxidise organic components in the Bayer liquor, characterised in that the wet oxidation process is conducted in the presence of a catalyst comprising a mixed Ce/Mn oxide.

2. A process as claimed in claim 1 wherein the catalyst has Ce atoms and Mn atoms homogenously dispersed therein.

3. A process as claimed in claim 1 or claim 2 wherein the catalyst has a molar ratio of Mn:Ce ranging from 1:99 to 99:1, more preferably from 10:1 to 1:10, even more preferably from 3:1 to 1:3.

4. A process as claimed in claim 3 wherein the catalyst has a ratio of Mn:Ce of from 0.5:0.5 to 0.8:0.2, more suitably 0.6:0.4 to 0.75:0.25.

5. A process as claimed in any one of the preceding claims wherein the catalyst includes one or more platinum group metals.

6. A process as claimed in claim 5 wherein the one or more platinum group metals are selected from platinum, palladium, ruthenium, and rhodium.

7. A process as claimed in claim 5 or claim 6 wherein the platinum group metal is present in an amount of up to 10% by weight of the Ce/Mn oxide.

8. A process as claimed in any one of the preceding claims wherein the catalyst has nano sized grains.

9. A process as claimed in claim 8 wherein the catalyst has an average grain size of up to 100 nm, or an average grain size of up to 50 nm, or an average grain size of up to 20 nm, or an average grain size of from 1 to 10 nm, or an average grain size of from 2 to 5 nm.

10. A process as claimed in any one of the preceding claims wherein the catalyst is provided in the form of particles of the Ce/Mn oxide.

11. A process as claimed in any one of claims 1 to 9 wherein the catalyst is supported on an inert support.

12. A process as claimed in claim 11 wherein the inert support comprises an oxide containing one or more of Ti, Fe and Ce.

13. A process as claimed in any one of the preceding claims wherein the catalyst has pores size in the range of from 5 to 250 nm.

14. A process as claimed in any one of the preceding claims wherein the wet oxidation treatment step is used to treat spent liquor from a sedimentation step or a precipitation step in the Bayer process.

15. A process as claimed in any one of the preceding claims wherein the wet oxidation treatment step is conducted at a temperature of from 200 to 315° C. and at a pressure of from 1 to 10 Mpa.

16. A wet oxidation catalyst used in a wet oxidation treatment of Bayer process liquors, the wet oxidation catalyst comprising a mixed Ce/Mn oxide material.

17. A catalyst as claimed in claim 16 wherein the catalyst has Ce atoms and Mn atoms homogenously dispersed therein.

18. A catalyst as claimed in claim 16 or claim 17 wherein the catalyst has a molar ratio of Mn:Ce ranging from 1:99 to 99:1, more preferably from 10:1 to 1:10, even more preferably from 3:1 to 1:3.

19. A catalyst as claimed in claim 18 wherein the catalyst has a ratio of Mn:Ce of from 0.5:0.5 to 0.8:0.2, more suitably 0.6:0.4 to 0.75:0.25.

20. A catalyst as claimed in any one of claims 16 to 19 wherein the catalyst includes one or more platinum group metals.

21. A catalyst as claimed in claim 20 wherein the one or more platinum group metals are selected from platinum, palladium, ruthenium, and rhodium.

22. A catalyst as claimed in claim 20 or claim 21 wherein the platinum group metal is present in an amount of up to 10% by weight of the Ce/Mn oxide.

23. A catalyst as claimed in any one of claims 16 to 22 wherein the catalyst has nano sized grains.

24. A catalyst as claimed in claim 23 wherein the catalyst has an average grain size of up to 100 nm, or an average grain size of up to 50 nm, or an average grain size of up to 20 nm, or an average grain size of from 1 to 10 nm, or an average grain size of from 2 to 5 nm.

25. A catalyst as claimed in any one of claims 16 to 24 wherein the catalyst is provided in the form of particles of the Ce/Mn oxide.

26. A catalyst as claimed in any one of claims 16 to 23 wherein the catalyst is supported on an inert support.

27. A catalyst as claimed in any one of claims 16 to 26 wherein the catalyst has pores size in the range of from 5 to 250 nm.
